(19) United States
(12) Patent Application Publication
(10) Pub. No.: US 2012/0065288 A1
(43) Pub. Date: Mar. 15, 2012

(54) METHOD OF MANUFACTURING NEOPRENE CONTAINING CARBON NANOTUBE

(76) Inventor: Young Hye Min, Seoul (KR)

(21) Appl. No.: 12/948,255

(22) Filed: Nov. 17, 2010

(30) Foreign Application Priority Data
Sep. 15, 2010 (JP) 2010-206967

(51) Int. Cl. C08J 9/00; B82Y 30/00

(52) U.S. Cl. 521/150; 977/742; 977/788

(57) ABSTRACT

Provided is a manufacturing method of a neoprene containing carbon nanotubes (CNT), and more particularly, a manufacturing method of a neoprene which contains the CNT having low weight and high tensile strength, and also contains vacuum glass balls having an excellent heat insulation effect such that elongation and a heat retaining property are excellent, and anions and far infrared rays are emitted. In a neoprene fabric manufactured by a method of manufacturing a neoprene containing carbon nanotubes of the present invention, the carbon nanotubes are uniformly distributed so that the fabric has good flexibility and is strong. Anions and far infrared rays are emitted as well, and the heat retaining property is excellent.

### TECHNICAL FIELD

The present invention relates to a manufacturing method of a neoprene containing carbon nanotubes (CNT), and more particularly, to a manufacturing method of a neoprene which contains CNT having low weight and high tensile strength, and also contains vacuum glass balls having excellent heat insulation effect such that elongation and heat retaining properties are excellent, and anions and far infrared rays are emitted.

### BACKGROUND ART

Nowadays, anions are receiving higher interest due to industrialization and severe pollution because the physiological functions of the human body become active when anions become abundant in the air. Also, cell activity is activated, and the immune system, the natural healing power source of the human body, is improved.

Also, far infrared rays are receiving greater interest, due to the fact that far infrared rays penetrate deeply into skin and may have a hyperthermic effect for muscular pain, arthralgia or the like.

Recently, neoprene, a highly resilient basic rubber containing chlorinated molecules and commonly called neoprene rubber (CR) in industry, was developed.

Neoprene has an excellent adhesive property, but is a crystalline rubber that solidifies when left standing for a long time, and is an alkali rubber.

Recently, functional compositions having various functions have been developed by adding other components to neoprene.

### DISCLOSURE

### Technical Problem

However, a typical neoprene composition is disadvantageous due to the following reasons.

(1) When a product is manufactured, it has low flexibility and is torn easily.

(2) With simple compositions, no functionality can be provided.

(3) Heat insulation and durability are not good.

### Technical Solution

There is provided a method of manufacturing a neoprene containing carbon nanotubes (CNT), including: preparing a material by mixing together about 1-3 parts by weight of the carbon nanotubes, about 31-42 parts by weight of toluene and about 2-4 parts by weight of a surfactant per 100 parts by weight of chloroprene (synthetic rubber); dispersing by putting the material into a mixer with a ceramic ball and mixing at high speed for about 6-7 hours; preparing a sub-material by mixing about 5-8 parts by weight of vacuum glass balls and about 3-5 parts by weight of anions and far infrared powders per 100 parts by weight of the chloroprene after the dispersing; redispersing by putting the sub-material into the mixer of the dispersing and mixing at low speed and high speed for about 3-5 hours; evaporating the toluene by leaving a material after the redispersing standing in a dry chamber for about 10-12 hours; synthesizing by uniformly distributing a material after the evaporating with the chloroprene in a two-roll mill; and foaming after aging about 3-4 hours after the synthesizing.

### Advantageous Effects

According to the present invention, the neoprene, which is manufactured by a method of manufacturing neoprene containing carbon nanotubes (CNT), provides the following effects.

(1) Since the carbon nanotubes are completely dispersed, the neoprene has a good flexibility and is strong.

(2) Anions and far infrared rays are emitted, and the carbon nanotubes are completely dispersed in two stages, thereby providing uniform distribution throughout an entire product.

(3) Since a heat retaining property is excellent and dispersion is uniform due to vacuum glass balls, reliability of an overall product is good.

### DESCRIPTION OF DRAWINGS

FIG. 1 is a flowchart illustrating a method of manufacturing neoprene containing carbon nanotubes (CNT) according to an embodiment of the present invention.

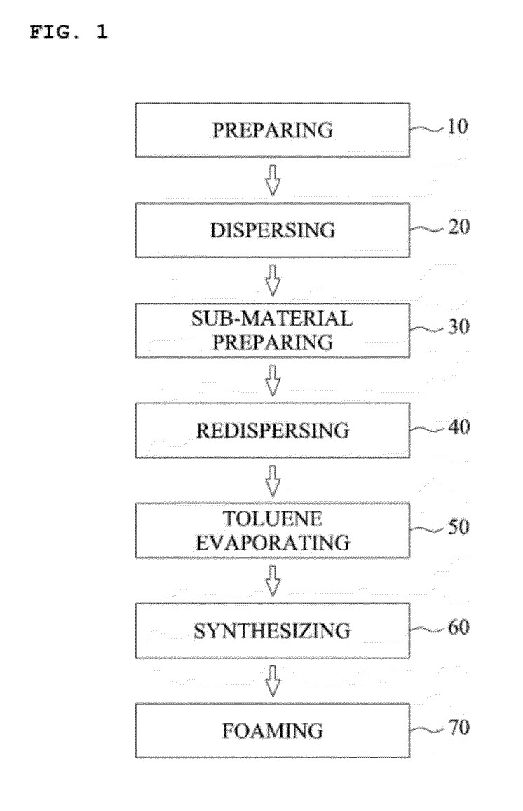

FIG. 2 is an electron micrograph showing neoprene containing carbon nanotubes according to an embodiment of the present invention.

### BEST MODE

According to the present invention, a method of manufacturing neoprene containing carbon nanotubes (CNT), including:

a preparing operation 10 which prepares a material by mixing together about 1-3 parts by weight of the carbon nanotubes, about 31-42 parts by weight of toluene and about 2-4 parts by weight of a surfactant per 100 parts by weight of chloroprene (synthetic rubber);

a dispersing operation 20 which puts the material into a mixer with a ceramic ball and mixes at high speed for about 6-7 hours;

a sub-material preparing operation 30 which prepares a sub-material by mixing about 5-8 parts by weight of vacuum glass balls and about 3-5 parts by weight of anions and far infrared powders per 100 parts by weight of the chloroprene after the dispersing operation 20;

a redispersing operation 40 which puts the sub-material into the mixer in the dispersing operation 20 and mixes at low and high speed for about 3-5 hours;

a toluene evaporating operation 50 which evaporates the toluene by leaving a material after the redispersing operation 40 standing in a dry chamber for about 10-12 hours;

a synthesizing operation 60 which uniformly distributes a material after the toluene evaporating operation 50 with the chloroprene in a two-roll mill; and a foaming operation 70 for foaming after aging for about 3-4 hours after the synthesizing operation 60.

In the preparing operation 10, a material is prepared by mixing together about 1-3 parts by weight of the carbon nanotubes, about 31-42 parts by weight of toluene and about 2-4 parts by weight of a surfactant per 100 parts by weight of chloroprene.

In the case where the toluene is less than about 31 parts by weight, a lot of heat is generated during dispersion so that product quality is deteriorated, and in the case where the toluene is more than about 42 parts by weight, dispersion is the same, but dispersion time is long.

The surfactant uses a mixture of a cationic surfactant and an anionic surfactant, and a commonly used dishwashing detergent is appropriate.

Inside the mixer in the dispersing operation 10, a disc-shaped mixing blade rotating at ultra-high speed (about 3000-4000 rpm) is formed, and ceramic balls (of less than about 1 mm), which are helpful for dispersion, are put into the mixer at about 10% by weight of total material.

In the dispersing operation 20, a mixing is performed by rotating the disc-shaped mixing blade at about 3000-4000 rpm for about 6-7 hours.

In the dispersing operation 20, dispersion is not complete with less than about 6 hours of the mixing, and more than about 7 hours of the mixing is not performed in consideration of the redispersion operation 40.

When undergoing the dispersing operation 20, the surfactant coats the surfaces of the carbon nanotubes, thereby dispersing them from each other to prevent them from agglomerating together.

The sub-material preparing operation 30 prepares the sub-material by mixing about 5-8 parts by weight of vacuum glass balls and about 3-5 parts by weight of the anions and the far infrared powders. The anion and the far infrared powders use powders of rare-earth natural stones.

The redispersion operation 40 is an operation in which the sub-material is put into the mixer after the dispersion operation 20 and mixed alternately at low speed and high speed.

The low speed and the high speed mixing of the redispersing operation 40 are performed by alternating rotation speeds between about 800-1000 rpm and about 2200-2500 rpm for 10 minute intervals, respectively.

In the redispersing operation 40, the speed is controlled for coating the anions and the far infrared powders with the surfactant as well as preventing the surfactant coated on the carbon nanotubes from breaking.

The toluene evaporating operation 50 is an operation which completely evaporates the toluene by leaving the mixture standing in a drying chamber maintained at a temperature of about 65-85° C.

The synthesizing operation 60 is an operation in which 100 parts by weight of the chloroprene per about 40 parts by weight of the toluene are put into a material including about 10-15 parts by weight of the toluene, and thereafter mixing is performed in a two-roll mill (a mechanical dispersion apparatus), and aging is carried out at room temperature for three days.

The forming operation 70 is the same foaming process used by a typical sponge manufacturing method, and work is performed in a state where the toluene is completely evaporated.

As described above, since the carbon nanotubes are completely dispersed inside the chloroprene, an increase in mechanical strengths, such as tensile strength, tear strength and compression set or the like caused by the carbon nanotubes, will be uniformly distributed in an overall rubber composition.

Also, anions and far infrared rays are emitted by means of the anions and the far infrared powders included in the redispersion operation 40.

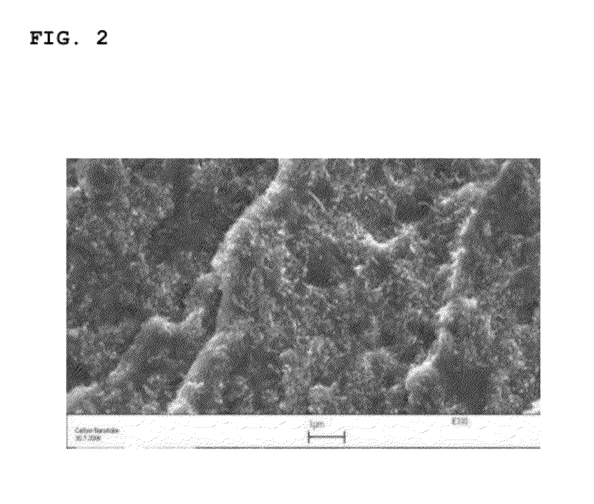

FIG. 2 is an electron micrograph of a neoprene fabric sample manufactured according to an embodiment of the present invention, where it can be found that the carbon nanotubes, the anions and the far infrared powders are uniformly distributed in the overall composition of matter.

The reason for distributing the carbon nanotubes as described above is that a decrease in the attraction force between the carbon nanotubes results from uniform surfactant coating on the surfaces of the carbon nanotubes by the toluene, thereby achieving the dispersion.

While the present invention has been particularly shown and described with reference to the accompanying drawings according to exemplary embodiments, it will be understood by those of ordinary skill in the art that various changes in form and details may be made therein without departing from the spirit and scope of the present invention as defined by the following claims.

1. A method of manufacturing a neoprene containing carbon nanotubes (CNT), the method comprising:
preparing a material by mixing together about 1-3 parts by weight of carbon nanotubes, about 31-42 parts by weight of toluene and about 2-4 parts by weight of a surfactant per 100 parts by weight of chloroprene (synthetic rubber);
dispersing the material by putting the material into a mixer with a ceramic ball and mixing at a high speed for about 6-7 hours;
preparing a sub-material by mixing about 5-8 parts by weight of vacuum glass balls and about 3-5 parts by weight of anions and far infrared powders per 100 parts by weight of the chloroprene after the dispersing;
performing redispersion by putting the sub-material into the mixer in the dispersing and mixing at a low and a high speed for about 3-5 hours;
evaporating the toluene by leaving the redispersed material standing in a drying chamber for about 10-12 hours;
performing synthesis by uniformly distributing the material after the evaporating with the chloroprene in a two-roll mill; and
performing foaming after aging for about 3-4 hours after the synthesizing.

2. The method of claim 1, wherein the low speed and the high speed mixing in the redispersing are performed by alternating rotating speed between about 800-1000 rpm and about 2200-2500 rpm at 10 minute intervals.
